(19) United States
(12) Patent Application Publication
(10) Pub. No.: US 2024/0102457 A1
(43) Pub. Date: Mar. 28, 2024

(54) HUMAN POWERED ELECTRICITY GENERATION DEVICE AND METHOD

(71) Applicant: Zhenkun Wang, Cambridge, MA (US)

(72) Inventor: Zhenkun Wang, Cambridge, MA (US)

(21) Appl. No.: 18/371,235

(22) Filed: Sep. 21, 2023

(30) Foreign Application Priority Data
Sep. 25, 2022 (CN) 202222538882.X

(51) Int. Cl. F03G 5/00; A63B 22/16; A63B 24/00

(52) U.S. Cl. CPC F03G 5/00; A63B 22/16; A63B 24/0087; A63B 2225/50; A63B 2230/08; F05B 2220/7064

(57) ABSTRACT

A human powered electricity generation device, comprising: a mechanism for receiving energy provided by a user; a first generator for receiving the energy provided by the user from the mechanism and generating electricity power; a power meter for measuring the electricity power generated by the first generator to be transmitted to an electricity power grid; an input device for receiving an identity of the user; and a processor, configured for following: receiving the identity of the user from the input device before the power meter measuring the generated electricity power; receiving information of the measured electricity power from the power meter; and outputting the information of the measured electricity power associated with the identity.

### CROSS REFERENCE TO RELATED PATENT APPLICATION

This patent application is based on a China patent application No. 202222538882.X filed on Sep. 25, 2022.

### FIELD OF THE INVENTION

The present invention relates to electricity generation, and more particularly, to man-powered electricity generation.

### BACKGROUND OF THE INVENTION

Electricity is one of the fundamental powers of modern life. Shortage of electricity constantly bothers modern societies. Currently, we rely on wind, solar, hydro, and carbon-based power generations. Activities and movements of human being also generates energies which may be converted into electricity.

However, the energies are wasted because it lacks of power generation mechanism to collect the energy. Therefore, it is desired to have a device which can convert the human power into electricity.

### SUMMARY OF THE INVENTION

According to an embodiment of the present application, a human powered electricity generation device is provided. It comprises: a mechanism for receiving energy provided by a user; a first generator for receiving the energy provided by the user from the mechanism and generating electricity power; a power meter for measuring the electricity power generated by the first generator to be transmitted to an electricity power grid; an input device for receiving an identity of the user; and a processor, configured for following: receiving the identity of the user from the input device before the power meter measuring the generated electricity power; receiving information of the measured electricity power from the power meter; and outputting the information of the measured electricity power associated with the identity.

Preferably, in order to provide exercise functionality to the user, the mechanism further comprises: a seesaw platform as a standing ground of the user, wherein the seesaw platform is pivoted in the middle; and a first transmission mechanism for connecting a first side of the seesaw platform with input of the first generator.

Preferably, in order to fully take advantage of seesaw mechanisms for electricity generation, the human powered electricity generation device further comprises: a second generator for receiving energy and generating electricity power; and a second transmission mechanism for connecting a second side of the seesaw platform with input of the second generator, wherein the power meter is further configured for measuring the electricity power generated by the second generator to be transmitted to the electricity power grid.

Preferably, in order to provide exercise functionality to the user, the mechanism further comprises one of following: a treadmill; a fitness bike; and a stepper machine.

Preferably, in order to provide user identity to the human powered electricity generation device, the input device is a card reader for accessing a card and reading the identity of the user.

Preferably, in order to store the information of the measured electricity power in a computer readable medium owned by the user, the processor is further configured for outputting the information of the measured electricity power associated with the identity to the card of the user via the card reader.

Preferably, in order to store the information of the measured electricity power in a cloud which can be accessed by the user, the human powered electricity generation device further comprises a networking device for connecting to an information system via a data network, wherein the processor is further configured for outputting the information of the measured electricity power associated with the identity to the information system via the networking device.

Preferably, in order to provide user identity to the human powered electricity generation device without any external memory device, the input device is a biometrics identifier for measuring biological features of the user, and wherein the processor is further configured for retrieving the identity of the user according to the measured biological features of the user.

Preferably, in order to store the user identities which are accessible by the human powered electricity generation device, the identity of the user is stored in one of following: a storage device of the human powered electricity generation device; and an information system which is accessible via a data network through a networking device of the human powered electricity generation device.

Preferably, in order to process the electricity before transmission, the human powered electricity generation device, further comprises: a regulator for regulating the electricity power generated; an AC-DC inverter for inverting the regulated electricity current from direct current to alternating current; and a transformer for transforming the inverted electricity to a higher voltage to be measured by the power meter.

In one embodiment of the present application, a human powered electricity generation method is provided. It comprises: receiving energy provided by a user by a mechanism; generating electricity power by a first generator which receives the energy from the mechanism; measuring the electricity power generated by the first generator by a power meter; transmitting the measured electricity power to an electricity power grid; receiving an identity of the user by an input device before the power meter measuring the generated electricity power; and outputting information of the measured electricity power associated with the identity.

Preferably, in order to provide exercise functionality to the user, the mechanism further comprises: a seesaw platform as a standing ground of the user, wherein the seesaw platform is pivoted in the middle; and a first transmission mechanism for connecting a first side of the seesaw platform with input of the first generator.

Preferably, in order to fully take advantage of seesaw mechanisms for electricity generation, the method further comprises: generating electricity power by a second generator which receives the energy from the mechanism; and measuring the electricity power generated by the second generator to be transmitted to the electricity power grid by the power meter; wherein the mechanism further comprises a second transmission mechanism for connecting a second side of the seesaw platform with input of the second generator.

Preferably, in order to provide exercise functionality to the user, the mechanism comprises one of following: a treadmill; a fitness bike; and a stepper machine.

Preferably, in order to provide user identity, the input device is a card reader for accessing a card and reading the identity of the user.

Preferably, in order to store information of the measured electricity power in a computer readable medium owned by the user, the method further comprises outputting the information of the measured electricity power associated with the identity to the card of the user via the card reader.

Preferably, in order to store information of the measured electricity power in a cloud which can be accessed by the user, the method further comprises outputting the information of the measured electricity power associated with the identity to an information system via a data network through a networking device.

Preferably, in order to provide user identity without any external memory device, the input device is a biometrics identifier for measuring biological features of the user, and the method further comprises: retrieving the identity of the user according to the measured biological features of the user.

Preferably, in order to store the user identities which are accessible, the identity of the user is stored in one of following: a storage device; and an information system which is accessible via a data network through a networking device.

Preferably, in order to process the electricity before transmission, the method further comprises: regulating the electricity power generated by a regulator; inverting the regulated electricity current from direct current to alternating current by an AC-DC inverter; and transforming, by the power meter, the inverted electricity to a higher voltage to be measured by the power meter.

The provided human powered electricity generation device and method can be used to convert user's energy into electricity while the user is exercising. The user who provides energy can be benefited from the electricity he/she generated in finance. In the meantime, the user's body also gets fit. Moreover, the information of the generated electricity may motivate the user to keep the exercise habit. Improvement of the electricity generated may also imply that the user's physical training gets well. In concluded, the provided human powered electricity generation device and method can benefit the society and the user financially, physically, and mentally.

### BRIEF DESCRIPTION OF THE DRAWINGS

The advantages and spirit related to the present invention can be further understood via the following detailed description and drawings.

FIG. 1 illustrates a block diagram of a human power electricity system 100 in accordance with an embodiment of the present application.

FIG. 2 depicts a block diagram of a human powered electricity generation device 110 in accordance with an embodiment of the present application.

FIG. 3 shows a view of a human powered electricity generation device 110 in accordance with an embodiment of the present application.

FIG. 4A illustrates a view of a human powered electricity generation device 110 in accordance with an embodiment of the present application.

FIG. 4B illustrates another view of the human powered electricity generation device 110 as shown in FIG. 4A.

FIG. 4C illustrates a front view of the human powered electricity generation device 110 as shown in FIG. 4A.

FIG. 4D illustrates a side view of the human powered electricity generation device 110 as shown in FIG. 4A.

FIG. 4E illustrates a top view of the human powered electricity generation device 110 as shown in FIG. 4A.

FIG. 5 depicts rear views of four states of the seesaw mechanism of the human powered electricity generation device 110 as shown in FIG. 4A.

FIG. 6 depicts a front view of the enlarged part of the seesaw mechanism of the human powered electricity generation device 110 as shown in FIG. 4A.

FIG. 7 illustrates a block diagram of a circuit assembly 450 or an electricity pathway in accordance with an embodiment of the present application.

FIG. 8 depicts a flowchart diagram of a human powered electricity generation method 800 in accordance with an embodiment of the present application.

### DETAILED DESCRIPTION OF THE PREFERRED EMBODIMENT

Some embodiments of the present application are described in details below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

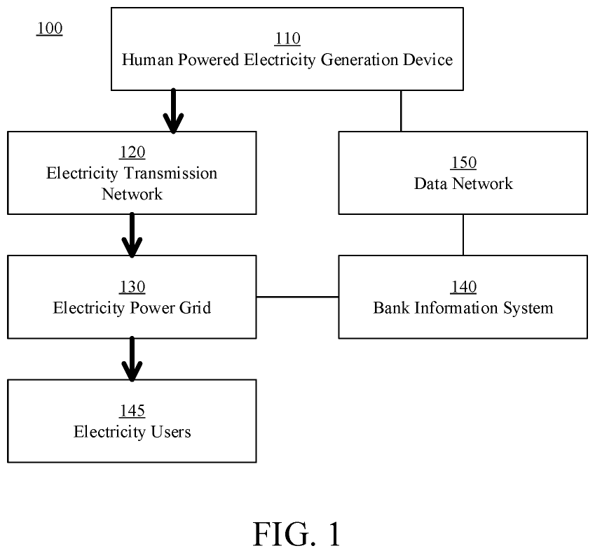

One of the objectives of the present application is to provide a human power electricity system for accounting personal contributions of electricity power. Please refer to FIG. 1, which illustrates a block diagram of a human power electricity system 100 in accordance with an embodiment of the present application. In the human power electricity system 100, it comprises at least one human powered electricity generation device 110 which transmits electricity power to an electricity power grid 130 via an electricity transmission network 120. The contributed electricity may be distributed to electricity users 145 of the electricity power grid 130. The human powered electricity generation device 100 also connects to a bank information system 140 via a data network 150.

The data network 150 may include wired or wireless local area networks, access networks and/or telecommunication networks. In one embodiment, the data network 150 may be private or virtually private. In another embodiment, the data network 150 may be Internet. Persons having ordinary skill in the art can understand how data network works for communicating a client (i.e., the human powered electricity generation device 110) and a server (i.e., the bank information system 140.)

In one embodiment, the human powered electricity generation device 110 may comprise an electricity generator which receives kinetic energy provided by its user and converts the kinetic energy into electricity. The generated electricity is fed into the electricity power grids 130 via the electricity transmission network 120. The generated electricity may be inverted into alternative current with higher voltage to reduce transmission loss.

In one embodiment, there may be a lot of the human powered electricity generation devices 110 in a place, such as a gym. The gym may have a power collection device for collecting electricity from these devices 110 and inverting and transmitting electricity to the electricity power grids. The power collection device may be considered as a part of the electricity transmission network 120.

The human powered electricity generation device 110 includes a computer terminal for identifying its user which provides the kinetic energy. There are several ways to identify the user. In one embodiment, the computer terminal may include a biometrics identifier to identify the user. The biometrics identifier may use one or more of following measurements of the user: fingerprint, palm veins, face recognition, DNA, palm print, hand geometry, iris recognition, retina, odor/scent, voice, shape of ears and gait. In another embodiment, the computer terminal may include a card reader to read an identification card such as a smart card of the user. The smart card may be read in contact with the card reader. Or the smart card may be read wirelessly by the card reader. In another embodiment, the computer terminal may include a barcode or a QR code scanner for scanning an identification code of the user.

The database of users may be stored in the bank information system 140 which also includes user account information. In between the computer terminal of the human powered electricity generation device 110 and the bank information system 140, AAA (authentication, authorization, and accounting) functionalities may be implemented. After the user is identified, the bank information system 140 knows who is using the human powered electricity generation device 110 and which bank account is associated with the identified user.

The human powered electricity generation device 110 may comprise a power meter for counting how much electricity is generated. The power meter may be authenticated, authorized, and accounted for the operator of the electricity power grid 130. The operator, i.e., usually a power company, buys the generated electricity from the user. The readings of the power meter may be reported to the operator and/or the bank information system 140. Since the power purchase rate may be varied from time to time, a purchase fee for the user may be calculated according to the amount of generated electricity and the power purchase rate at the time. After the purchase fee is agreed by the operator, the bank information system 140 may transfer the purchase fee from a bank account of the operator to the bank account of the user.

In an alternative embodiment, the amount of the generated electricity and/or the calculated purchase fee may be recorded in the smart card of the user or recoded in the bank information system 140. In a later time, the user may claim the purchase fee according to the recorded amount of the generated electricity or the calculated purchase fee. Or the user may deduct his/her own electricity fee according to the recorded amount of the generated electricity or the calculated purchase fee.

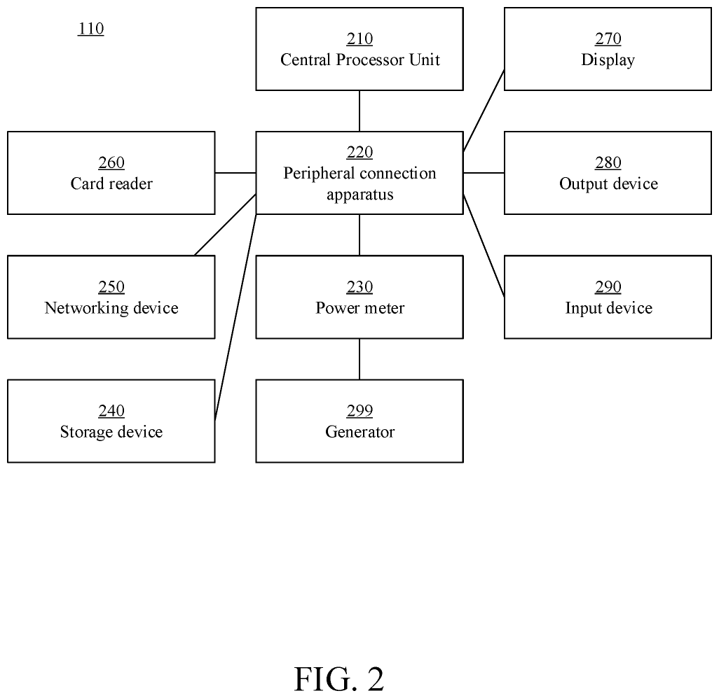

Please refer to FIG. 2, which depicts a block diagram of a human powered electricity generation device 100 in accordance with an embodiment of the present application. The human powered electricity generation device 110 may comprises a CPU (Central Processing Unit) 210 for controlling the human powered electricity generation device 110 which is a part of the human power electricity system 100. The CPU 210 may embody one of popular x86, x64, ARM, RISC-V, Sparc, or any other instruction set. The CPU 210 may be configured to run an operating system and application programs for controlling the human powered electricity generation device 110. Although there is no system memory shown in FIG. 2, the human powered electricity generation device 110 includes system memory for operations of the CPU 210.

As shown in FIG. 2, the human powered electricity generation device 110 may further comprises following components: at least one peripheral connection apparatus 220, a power meter 230, a storage device 240, a networking device 250, a card reader 260, a display 270, an output device 280, an input device 290, and a generator 299 for receiving kinetic energy and generating electricity.

The at least one peripheral connection apparatus 220 may include connection interfaces for connecting other components and the CPU 210. These connection interfaces may be compliant with industry standards, such as USB, PCI-Express, PCI, SCSI, iSCSI, SATA, ATA, UART, IEEE 1394, etc.

The generator 299 is configured for receiving kinetic energy and generating electricity. Moreover, it may include a inverter for inverting generated DC (direct current) into AC. It may also include a transformer for transforming lower voltage of the generated electricity into higher voltage to reduce transmission loss.

The power meter 230 or the electricity meter 230 is configured for measuring electricity volume which the generator 299 transmits to the electricity power grid 130. The measured electricity volume is supposed to be transmitted to the operating system or a driver program run by the operating system periodically or responsively. Readout of the power meter 299 may be in units of watt per hour. In order to make sure that metering function of the power meter 230 is accurate enough, the power meter 230 may be authenticated by the operator of the electricity power grid 130.

The storage device 240 may include non-volatile memory such as EEPROM, flash, hard drive, optical drive or any other memory for storing the operating system and application programs which implements functions provided by the present application.

The card reader 260 may be configured to read a smart card or IC (integrated circuit) card wirelessly or in contact. The smart card may include a memory for storing information with regard to the identity of its owner or the user of the human powered electricity generation device 110. In an embodiment, the memory of the smart card may be used to store electricity volume generated by the user. The smart card and the card reader 260 may facilitate encryption and decryption functionalities to protect sensitive information stored in the smart card. For example, the smart card, the card reader 260, and the human powered electricity generation device 110 may be complaint with industrial information safety standards for credit cards, debit cards, contactless credit cards and debit cards. In some embodiments, the smart card may be a normal credit card, a debit card, or any other identity cards issued by the bank which is incorporated with the operator of the electricity power grid 130.

The display 270 may be optional. It may be replaced by few liquid crystal digits or LEDs. The human powered electricity generation device 110 may show the electricity volume measured by the power meter 230 on the display 270 to notify and to encourage the user for his/her contributions.

The human powered electricity generation device 110 may include output devices 280 such as speaker, printer, lights. In the other hands, the human powered electricity generation device 110 may include input devices 290 such as scanner, camera, keyboard, key, mouse, touch pad, touch screen, and abovementioned biometrics device for measuring the user. For example, instead of using the card reader 260, the input device 290 may be used to receive password, challenge answer, or biometric features to identify the user.

The human powered electricity generation device 110 is configured for receiving energy provided by the user. The mechanism of the generator 299 may be implemented in a treadmill, a weight lift machine, a fitness bike, stepper machine, or any other kinds of fitness machines found in a gym etc.

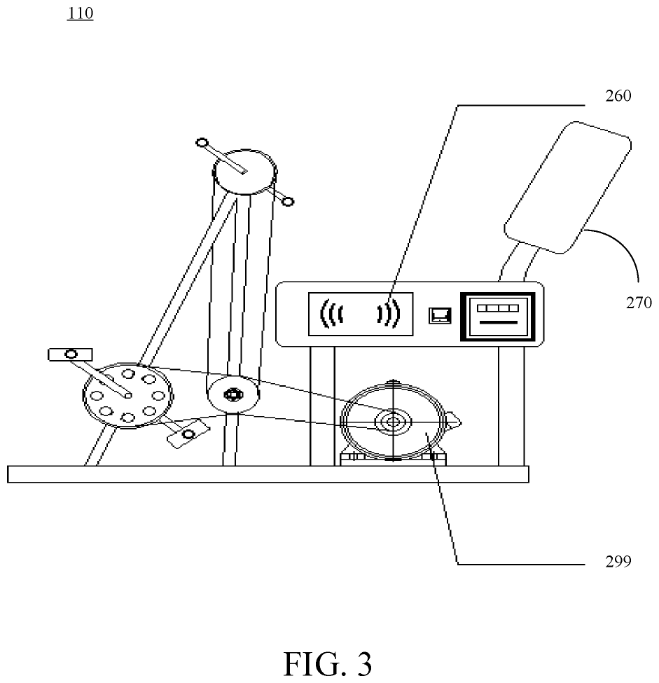

Please refer to FIG. 3, which shows a view of a human powered electricity generation device 110 in accordance with an embodiment of the present application. As shown in FIG. 3, the generator 299 is configured to receive energy transmitted by chains from at least one of two wheels. The lower wheel includes two pedals for feet. The upper wheel includes two handles for hands. The user can turn at least one of these two wheels by hands or by feet. The turning wheels transmit energy provided by the user to the generator 299. In one embodiment, the generator 299 may include a set of gears to well receive the energy from the chains. The received kinetic energy would be transformed into electricity to be transmitted to the electricity power grid 130.

As shown in FIG. 3, a contactless card reader 260 is installed. The user can use the card reader 260 to read his/her smart card or IC card for identifying himself/herself before providing energy to the wheels. A display 270 can show the readout of the power meter 230.

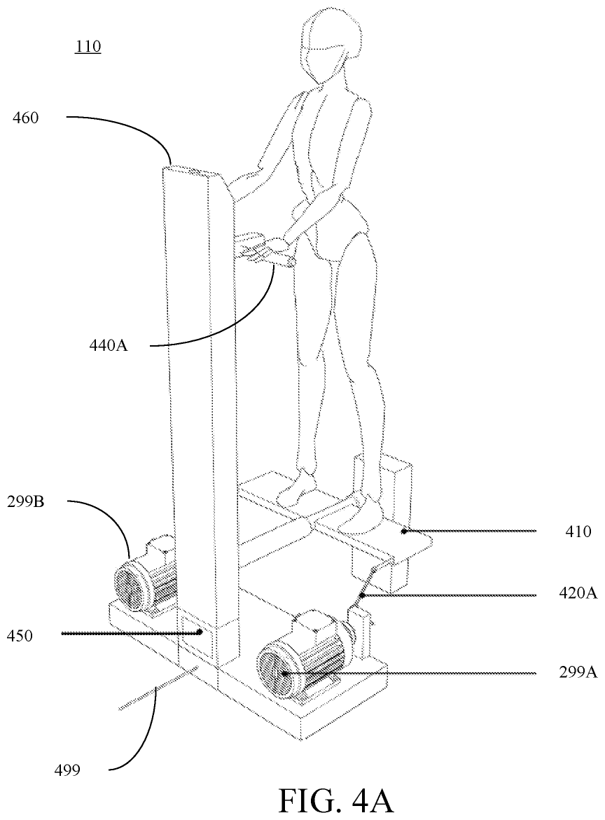

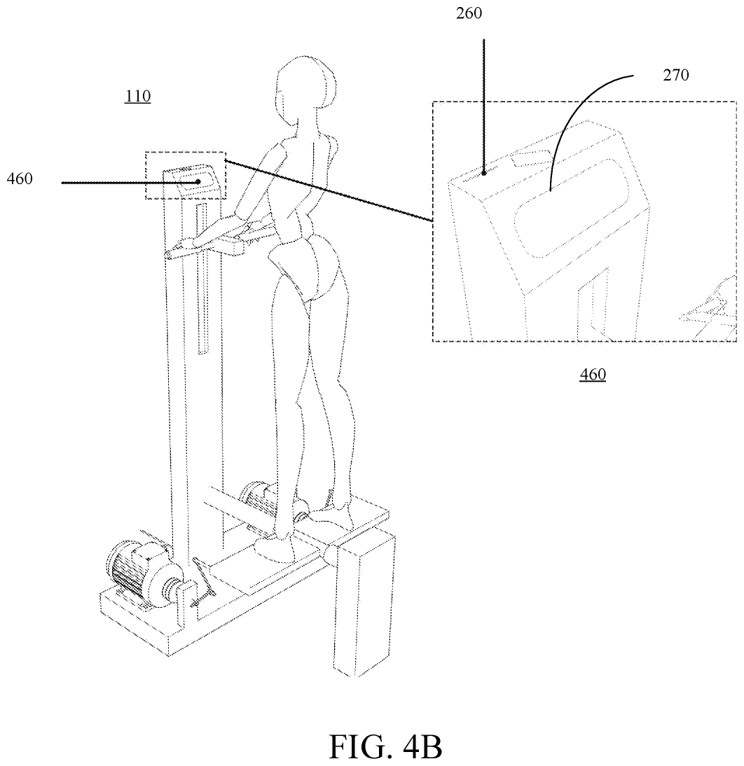

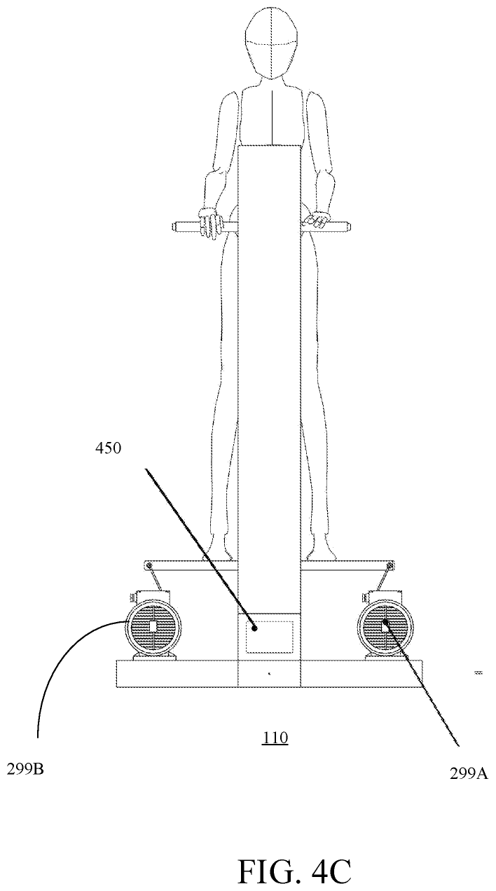

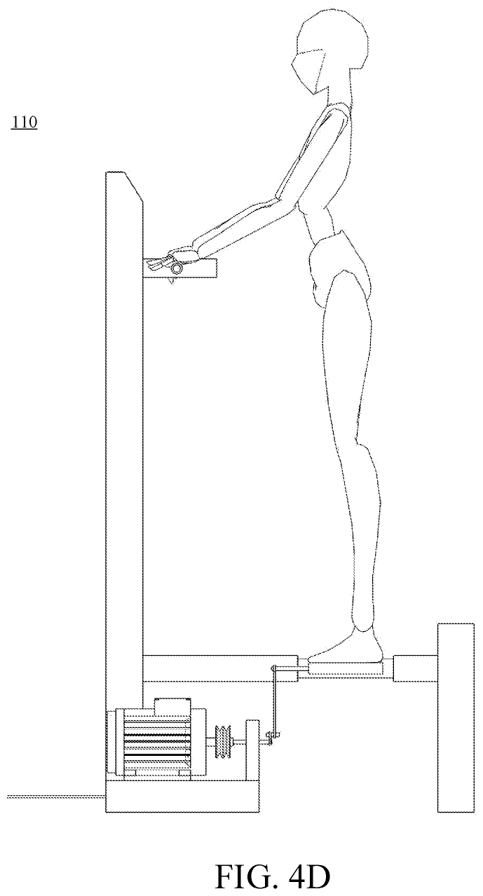

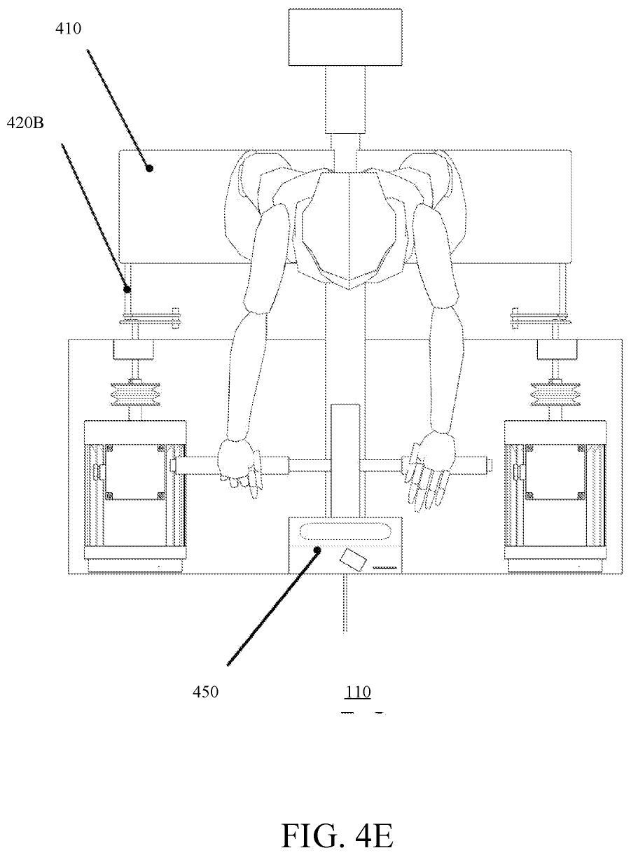

Please refer to FIG. 4A, which illustrates a view of a human powered electricity generation device 110 in accordance with an embodiment of the present application. The human powered electricity generation device 110 as shown in FIG. 4A may include components as shown in FIG. 2 and further comprises a seesaw mechanism connected to two generators 299A and 299B.

The seesaw mechanism includes a platform 410 as pedals for the user's feet. A pivot is arranged in the middle of the platform 410. The user may swing the pedals by feet. Under two sides of the platform 410, there exists two transmission mechanisms 420A and 420B connected to the generators 299A and 299B, respectively. When a first part of the platform 410 is pressed downwardly and lifted upwardly, the first transmission mechanism 420A turns its corresponding generator 299A for generating electricity. Similarly, when a second part or a counterpart of the first part of the platform 410 is pressed downwardly and lifted upwardly, the second transmission mechanism 420B turns its corresponding generator 299B for generating electricity.

In one embodiment, the transmission mechanism 420 may include a crank coupling to input shaft of the generator 299. The crank coupling may include a connecting hand which are pivoted at the platform and input of the generator 299. There may be one or more gears attached to the crank coupling.

Although there are two transmission mechanisms 420A and 420B and their corresponding generators 299A and 299B in the embodiment as shown in FIG. 4A, the human powered electricity generation device 110 may include only one of the two transmission mechanisms 420A and 420B and one of their corresponding generators 299A and 299B. In other words, in case a pair of the transmission mechanism 420 and its corresponding generator 299 is broken, the remaining pair of the transmission mechanism 420 and its corresponding generator 299 can still provide electricity power generation function although some inputted energy may not be utilized.

As shown in FIG. 4A, there is a tall standing structure for a console 460 and two handles 440A and 440B. Some of the components of the human powered electricity generation device 110 as shown in FIG. 2 may be installed inside the standing structure. The console 460 may include the input and output devices as shown in FIG. 2. A power cord 499 is used to transmit generated electricity to the electricity power grid 130 via the electricity transmission network 120.

Two generators 299 and the tall standing structure are placed on top of a generator platform. The pivot axis of the seesaw mechanism is supported by the tall standing structure and another shorter supporting structure. Although for heat sinking there is no cover structure for the generators 299 and the transmission mechanisms 420 as shown in FIG. 4A, there may be one or more cover structures for these components to prevent hurting the user or damaging the components.

Please refer to FIG. 4B, which illustrates another view of the human powered electricity generation device 110 as shown in FIG. 4A. The area shows the console 460 of the human powered electricity generation device 110 is enlarged. As shown in the right side of FIG. 4B, the console 460 may include a panel of the card reader 260 and the display 270. When the user exercises and provides energy, the hands can hold the two handles to keep balance. The height of the two handles 440 may be adjustable along a vertical structure on the tall standing structure.

Please refer to FIG. 4C, which illustrates a front view of the human powered electricity generation device 110 as shown in FIG. 4A. A circuit assembly 450 may be included in between the two generators 299A and 299B. The circuit assembly 450 may be used to prepare the electricity from at least one of the generators 299A and 299B for transmission.

Please refer to FIG. 4D, which illustrates a side view of the human powered electricity generation device 110 as shown in FIG. 4A. Please refer to FIG. 4E, which illustrates a top view of the human powered electricity generation device 110 as shown in FIG. 4A.

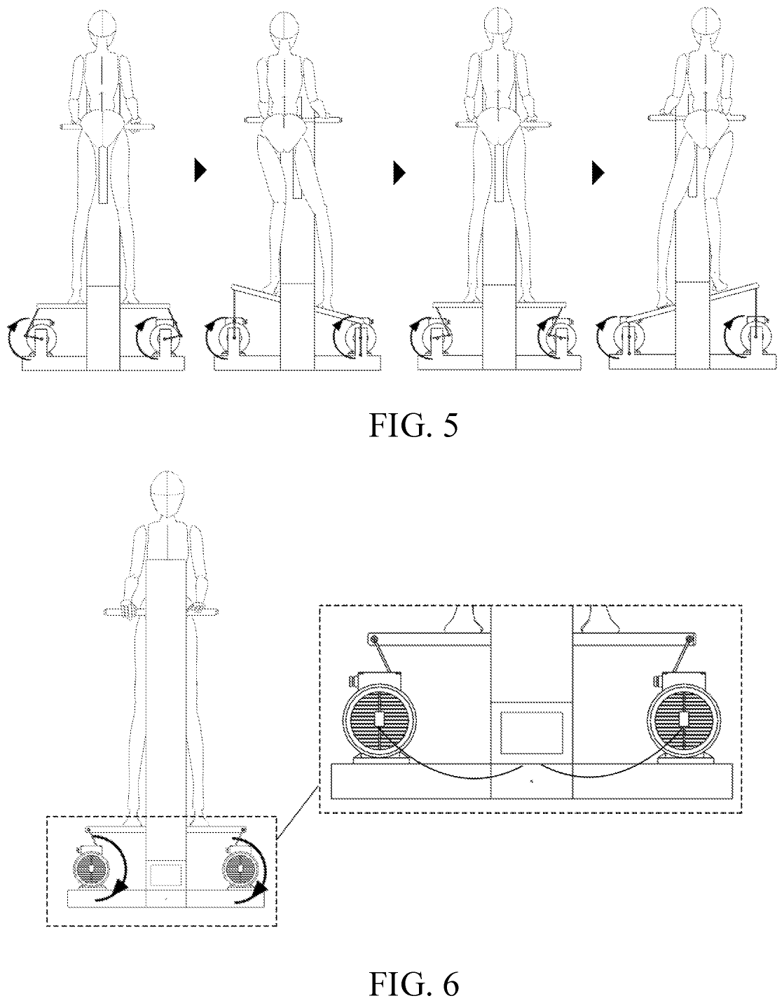

Please refer to FIG. 5, which depicts rear views of four states of the seesaw mechanism of the human powered electricity generation device 110 as shown in FIG. 4A. As shown in FIG. 5, the two transmission mechanisms 420A and 420B may be configured to turn the generators 299A and 299B in one direction, said clockwise or counterclockwise. This design can use the same kind of generators in both sides. Because they are turned in the same direction, the two generators 299A and 299B may generate electric currents in the same direction. Therefore, as shown in FIG. 5, the connecting hands of the two transmission mechanisms 420A and 420B are configured to be outwardly or inwardly when the seesaw platform 410 is in parallel to the horizon. The connecting hands of the two transmission mechanisms 420A and 420B may be positioned differently from a half cycle or 180 degrees.

Please refer to FIG. 6, which depicts a front view of the enlarged part of the seesaw mechanism of the human powered electricity generation device 110 as shown in FIG. 4A. Already mentioned in the previous paragraph, the two connecting hands of the two transmission mechanisms 420A and 420B may be configured to be outwardly or inwardly when the seesaw platform 410 is in parallel to the horizon. Two power cords from the two generators 299A and 299B are connected to the circuit assembly 450 for power transmissions.

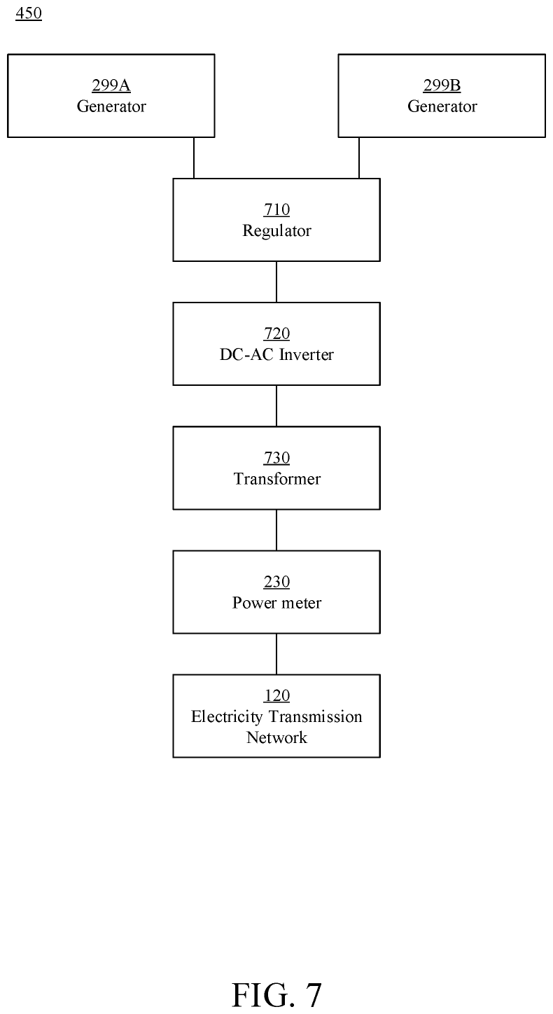

Please refer to FIG. 7, which illustrates a block diagram of a circuit assembly 450 or an electricity pathway in accordance with an embodiment of the present application. The circuit assembly 450 may comprises one or more generators 299, a regulator 710, a DC-AC Inverter 720, and a transformer 730. As shown in FIG. 7, the regulator 710 is configured to receive electricity from two generators 299A and 299B and to regulate the direct currents. It is used to change fluctuating voltages of the input to a defined and stable voltage. The regulated direct current may be passed through one or a set of DC-AC inverter 720 for inverting DC into AC. The transformer 730 is used to raise voltage of the alternating current before feeding the power meter 230.

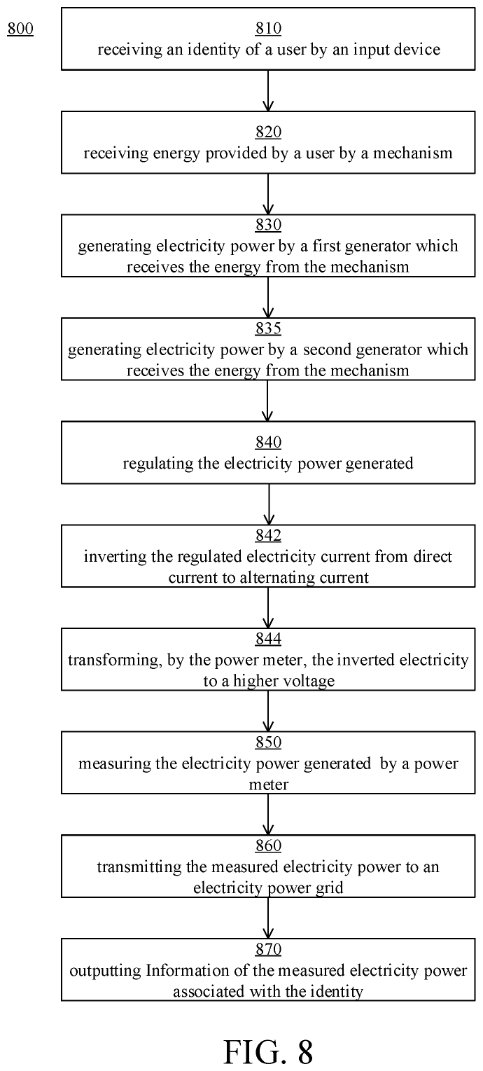

Please refer to FIG. 8, which depicts a flowchart diagram of a human powered electricity generation method 800 in accordance with an embodiment of the present application. The human powered electricity generation method 800 may be implemented by the human powered electricity generation device 110 provided in the embodiments. If any two steps have no causal relationship, the present application does not limit the sequence of these two steps. The human powered electricity generation method 800 may begin with step 810.

Step 810: receiving an identity of a user by an input device. In one embodiment, the input device is a card reader for accessing a card and reading the identity of the user. In another embodiment, the input device is a biometrics identifier for measuring biological features of the user. The step 810 may comprises retrieving the identity of the user according to the measured biological features of the user. The identity of the user is stored in one of following: a storage device; and an information system which is accessible via a data network through a networking device.

Step 820: receiving energy provided by a user by a mechanism. In one embodiment, the mechanism further comprises: a seesaw platform as a standing ground of the user, wherein the seesaw platform is pivoted in the middle; and a first transmission mechanism for connecting a first side of the seesaw platform with input of the first generator.

Step 830: generating electricity power by a first generator which receives the energy from the mechanism. In one embodiment, the mechanism may comprises one of following: a treadmill; a fitness bike; and a stepper machine.

Optional step 835: generating electricity by a second generator which receives the energy from the mechanism. In one embodiment, the mechanism may further comprises a second transmission mechanism for connecting a second side of the seesaw platform with input of the second generator.

Optional step 840: regulating, by a regulator, the electricity power generated from the first generator and/or the second generator.

Optional step 842: inverting the regulated electricity current from direct current to alternating current by an AC-DC inverter.

Optional step 844: transforming, by the power meter, the inverted electricity to a higher voltage to be measured by a power meter.

Step 850: measuring the electricity power generated by a power meter.

Step 860: transmitting the measured electricity power to an electricity power grid.

Step 870: outputting information of the measured electricity power associated with the identity. In one embodiment, the step outputs the information of measured electricity power associated with the identity to the card of the user via the card reader. In another embodiment, the steps outputs the information of the measured electricity power associated with the identity to an information system via a data network through a networking device.

According to an embodiment of the present application, a human powered electricity generation device is provided. It comprises: a mechanism for receiving energy provided by a user; a first generator for receiving the energy provided by the user from the mechanism and generating electricity power; a power meter for measuring the electricity power generated by the first generator to be transmitted to an electricity power grid; an input device for receiving an identity of the user; and a processor, configured for following: receiving the identity of the user from the input device before the power meter measuring the generated electricity power; receiving information of the measured electricity power from the power meter; and outputting the information of the measured electricity power associated with the identity.

Preferably, in order to provide exercise functionality to the user, the mechanism further comprises: a seesaw platform as a standing ground of the user, wherein the seesaw platform is pivoted in the middle; and a first transmission mechanism for connecting a first side of the seesaw platform with input of the first generator.

Preferably, in order to fully take advantage of seesaw mechanisms for electricity generation, the human powered electricity generation device further comprises: a second generator for receiving energy and generating electricity power; and a second transmission mechanism for connecting a second side of the seesaw platform with input of the second generator, wherein the power meter is further configured for measuring the electricity power generated by the second generator to be transmitted to the electricity power grid.

Preferably, in order to provide exercise functionality to the user, the mechanism further comprises one of following: a treadmill; a fitness bike; and a stepper machine.

Preferably, in order to provide user identity to the human powered electricity generation device, the input device is a card reader for accessing a card and reading the identity of the user.

Preferably, in order to store the information of the measured electricity power in a computer readable medium owned by the user, the processor is further configured for outputting the information of the measured electricity power associated with the identity to the card of the user via the card reader.

Preferably, in order to store the information of the measured electricity power in a cloud which can be accessed by the user, the human powered electricity generation device further comprises a networking device for connecting to an information system via a data network, wherein the processor is further configured for outputting the information of the measured electricity power associated with the identity to the information system via the networking device.

Preferably, in order to provide user identity to the human powered electricity generation device without any external memory device, the input device is a biometrics identifier for measuring biological features of the user, and wherein the processor is further configured for retrieving the identity of the user according to the measured biological features of the user.

Preferably, in order to store the user identities which are accessible by the human powered electricity generation device, the identity of the user is stored in one of following: a storage device of the human powered electricity generation device; and an information system which is accessible via a data network through a networking device of the human powered electricity generation device.

Preferably, in order to process the electricity before transmission, the human powered electricity generation device, further comprises: a regulator for regulating the electricity power generated; an AC-DC inverter for inverting the regulated electricity current from direct current to alternating current; and a transformer for transforming the inverted electricity to a higher voltage to be measured by the power meter.

In one embodiment of the present application, a human powered electricity generation method is provided. It comprises: receiving energy provided by a user by a mechanism; generating electricity power by a first generator which receives the energy from the mechanism; measuring the electricity power generated by the first generator by a power meter; transmitting the measured electricity power to an electricity power grid; receiving an identity of the user by an input device before the power meter measuring the generated electricity power; and outputting information of the measured electricity power associated with the identity.

Preferably, in order to provide exercise functionality to the user, the mechanism further comprises: a seesaw platform as a standing ground of the user, wherein the seesaw platform is pivoted in the middle; and a first transmission mechanism for connecting a first side of the seesaw platform with input of the first generator.

Preferably, in order to fully take advantage of seesaw mechanisms for electricity generation, the method further comprises: generating electricity power by a second generator which receives the energy from the mechanism; and measuring the electricity power generated by the second generator to be transmitted to the electricity power grid by the power meter; wherein the mechanism further comprises a second transmission mechanism for connecting a second side of the seesaw platform with input of the second generator.

Preferably, in order to provide exercise functionality to the user, the mechanism comprises one of following: a treadmill; a fitness bike; and a stepper machine.

Preferably, in order to provide user identity, the input device is a card reader for accessing a card and reading the identity of the user.

Preferably, in order to store information of the measured electricity power in a computer readable medium owned by the user, the method further comprises outputting the information of the measured electricity power associated with the identity to the card of the user via the card reader.

Preferably, in order to store information of the measured electricity power in a cloud which can be accessed by the user, the method further comprises outputting the information of the measured electricity power associated with the identity to an information system via a data network through a networking device.

Preferably, in order to provide user identity without any external memory device, the input device is a biometrics identifier for measuring biological features of the user, and the method further comprises: retrieving the identity of the user according to the measured biological features of the user.

Preferably, in order to store the user identities which are accessible, the identity of the user is stored in one of following: a storage device; and an information system which is accessible via a data network through a networking device.

Preferably, in order to process the electricity before transmission, the method further comprises: regulating the electricity power generated by a regulator; inverting the regulated electricity current from direct current to alternating current by an AC-DC inverter; and transforming, by the power meter, the inverted electricity to a higher voltage to be measured by the power meter.

The provided human powered electricity generation device and method can be used to convert user's energy into electricity while the user is exercising. The user who provides energy can be benefited from the electricity he/she generated in finance. In the meantime, the user's body also gets fit. Moreover, the information of the generated electricity may motivate the user to keep the exercise habit. Improvement of the electricity generated may also imply that the user's physical training gets well. In concluded, the provided human powered electricity generation device and method can benefit the society and the user financially, physically, and mentally.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A human powered electricity generation device, comprising:
a mechanism for receiving energy provided by a user;
a first generator for receiving the energy provided by the user from the mechanism and generating electricity power;
a power meter for measuring the electricity power generated by the first generator to be transmitted to an electricity power grid;
an input device for receiving an identity of the user; and
a processor, configured for following:
receiving the identity of the user from the input device before the power meter measuring the generated electricity power;
receiving information of the measured electricity power from the power meter; and
outputting the information of the measured electricity power associated with the identity.

2. The human powered electricity generation device of claim 1, wherein the mechanism further comprises:
a seesaw platform as a standing ground of the user, wherein the seesaw platform is pivoted in the middle; and
a first transmission mechanism for connecting a first side of the seesaw platform with input of the first generator.

3. The human powered electricity generation device of claim 2, further comprises:
a second generator for receiving energy and generating electricity power; and
a second transmission mechanism for connecting a second side of the seesaw platform with input of the second generator,
wherein the power meter is further configured for measuring the electricity power generated by the second generator to be transmitted to the electricity power grid.

4. The human powered electricity generation device of claim 1, wherein the mechanism comprises one of following:
a treadmill;
a fitness bike; and
a stepper machine.

5. The human powered electricity generation device of claim 1, wherein the input device is a card reader for accessing a card and reading the identity of the user.

6. The human powered electricity generation device of claim 5, wherein the processor is further configured for outputting the information of the measured electricity power associated with the identity to the card of the user via the card reader.

7. The human powered electricity generation device of claim 1, further comprises a networking device for connecting to an information system via a data network, wherein the processor is further configured for outputting the information of the measured electricity power associated with the identity to the information system via the networking device.

8. The human powered electricity generation device of claim 1, wherein the input device is a biometrics identifier for measuring biological features of the user, and
wherein the processor is further configured for retrieving the identity of the user according to the measured biological features of the user.

9. The human powered electricity generation device of claim 8, wherein the identity of the user is stored in one of following:
a storage device of the human powered electricity generation device; and
an information system which is accessible via a data network through a networking device of the human powered electricity generation device.

10. The human powered electricity generation device of claim 1, further comprises:
a regulator for regulating the electricity power generated;
an AC-DC inverter for inverting the regulated electricity current from direct current to alternating current; and
a transformer for transforming the inverted electricity to a higher voltage to be measured by the power meter.

11. A human powered electricity generation method, comprising:
receiving energy provided by a user by a mechanism;
generating electricity power by a first generator which receives the energy from the mechanism;
measuring the electricity power generated by the first generator by a power meter;
transmitting the measured electricity power to an electricity power grid;
receiving an identity of the user by an input device before the power meter measuring the generated electricity power; and
outputting information of the measured electricity power associated with the identity.

12. The human powered electricity generation method of claim 11, wherein the mechanism further comprises:
a seesaw platform as a standing ground of the user, wherein the seesaw platform is pivoted in the middle; and
a first transmission mechanism for connecting a first side of the seesaw platform with input of the first generator.

13. The human powered electricity generation method of claim 12, further comprises:
generating electricity power by a second generator which receives the energy from the mechanism; and
measuring the electricity power generated by the second generator to be transmitted to the electricity power grid by the power meter;
wherein the mechanism further comprises a second transmission mechanism for connecting a second side of the seesaw platform with input of the second generator.

14. The human powered electricity generation method of claim 11, wherein the mechanism comprises one of following:
a treadmill;
a fitness bike; and
a stepper machine.

15. The human powered electricity generation method of claim 11, wherein the input device is a card reader for accessing a card and reading the identity of the user.

16. The human powered electricity generation method of claim 15, further comprises:
outputting the information of the measured electricity power associated with the identity to the card of the user via the card reader.

17. The human powered electricity generation method of claim 11, further comprises:
outputting the information of the measured electricity power associated with the identity to an information system via a data network through a networking device.

18. The human powered electricity generation method of claim 11, wherein the input device is a biometrics identifier for measuring biological features of the user, and
wherein the human powered electricity generation method further comprises: retrieving the identity of the user according to the measured biological features of the user.

19. The human powered electricity generation method of claim 18, wherein the identity of the user is stored in one of following:
a storage device; and
an information system which is accessible via a data network through a networking device.

20. The human powered electricity generation method of claim 1, further comprises:
regulating the electricity power generated by a regulator;
inverting the regulated electricity current from direct current to alternating current by an AC-DC inverter; and
transforming, by the power meter, the inverted electricity to a higher voltage to be measured by the power meter.
